(19) United States
(12) Patent Application Publication
(10) Pub. No.: US 2018/0314326 A1
(43) Pub. Date: Nov. 1, 2018

(54) VIRTUAL SPACE POSITION DESIGNATION METHOD, SYSTEM FOR EXECUTING THE METHOD AND NON-TRANSITORY COMPUTER READABLE MEDIUM

(71) Applicant: COLOPL, Inc., Tokyo (JP)

(72) Inventor: Shuhei TERAHATA, Tokyo (JP)

(21) Appl. No.: 15/735,594

(22) PCT Filed: Jun. 6, 2016
(86) PCT No.: PCT/JP2016/066812

§ 371 Date: Dec. 11, 2017

(30) Foreign Application Priority Data
Jun. 12, 2015 (JP) 2015-119250

(51) Int. Cl. G06F 3/01; G06T 19/00

(52) U.S. Cl. CPC G06F 3/013; G06F 3/012; G06T 19/006

(57) ABSTRACT

In a method involving determining a point of gaze based on an actual line of sight and displaying a cursor or a pointer at that place to designate a position in a virtual space, the following problem has occurred. When it is considered that a normal line of sight is in a direction of slightly looking downward, it is not easy to designate a position on an object that does not always have a large apparent area as viewed from the operator side, like an upper surface or a lower surface of the object. A provisional line of sight for designating the object being a target of operation is output not from a position of an eye of the operator in the virtual space but from a position separated from the position of the eye by a certain first distance in an up-down direction. Further, an angle α is formed in a vertical direction between the provisional line of sight and an actual line of sight output from the position of the eye of the operator so that the provisional line of sight intersects with the actual line of sight at a position separated by a certain second distance in a horizontal direction.

### RELATED APPLICATIONS

The present application is a National Stage of PCT International Application No. PCT/JP2016/066812, filed Jun. 6, 2016, which claims priority to Japanese Patent Application No. 2015-119250 filed Jun. 12, 2015.

### TECHNICAL FIELD

This disclosure relates to position designation in a virtual space, for identifying, in a virtual reality space (VR) or an augmented reality space (AR), an object that is an operator's target of operation in order for an operator to perform operation.

### BACKGROUND ART

In Patent Literatures 1 and 2, there is described a technology of determining a point on which an operator wearing a head-mounted display (HMD) focuses his or her gaze based on a line of sight of the operator, to thereby display a cursor or a pointer for indicating a point of gaze at that point.

### CITATION LIST

### Patent Literature

[PTL 1] JP 06-337756 A
[PTL 2] JP 09-128138 A

### SUMMARY

However, in the technology described in Patent Literatures 1 and 2, designating a part of an object in a virtual space, which has a small apparent area as viewed from the operator side, is difficult. This disclosure helps to enable easy designation of a predetermined position of an object in a virtual space.

According to at least one embodiment of this disclosure, there are provided a virtual space position designation method and a device in which a provisional line of sight for designating a position in a virtual space is output not from a position of an eye of an operator in the virtual space but from a position separated from the position of the eye by a certain first distance in an up-down direction, and an angle α is formed in a vertical direction between the provisional line of sight and an actual line of sight output from the position of the eye of the operator so that the provisional line of sight intersects with the actual line of sight at a position separated by a certain second distance in a horizontal direction.

According to some embodiments of this disclosure, the predetermined position of the object in the virtual space can be easily designated.

Other features and advantages of this disclosure are made clear from the description of at least one embodiment of this disclosure, the accompanying drawings, and the appended claims.

### BRIEF DESCRIPTION OF DRAWINGS

FIG. 1 is a diagram of a relationship among a position of an eye of an operator, a provisional line of sight, and an actual line of sight according to at least one embodiment.

FIG. 2 is a diagram of a relationship in a first example in which a point of gaze is determined based on the provisional line of sight according to at least one embodiment.

FIG. 3 is a diagram of a field of view of the first example according to at least one embodiment.

FIG. 4 is diagram of a relationship of a second example in which the point of gaze is determined based on the provisional line of sight according to at least one embodiment.

FIG. 5 is a diagram of the field of view of the second example according to at least one embodiment.

FIG. 6 is a diagram of a relationship of a third example in which the point of gaze is determined based on the provisional line of sight according to at least one embodiment.

FIG. 7 is a diagram of the field of view of the third example according to at least one embodiment.

FIG. 8 is a diagram of a relationship of a fourth example in which the point of gaze is determined based on the provisional line of sight according to at least one embodiment.

FIG. 9 is a diagram of the field of view of the fourth example according to at least one embodiment.

FIG. 10 is a diagram of a first example of how the provisional line of sight moves when the actual line of sight is swung in an up-down direction according to at least one embodiment.

FIG. 11 is a diagram of a second example of how the provisional line of sight moves when the actual line of sight is swung in the up-down direction according to at least one embodiment.

FIG. 12 is a diagram of a third example of how the provisional line of sight moves when the actual line of sight is swung in the up-down direction according to at least one embodiment.

FIG. 13 is a field of view diagram in which a star pointer P having a thickness is displayed on a surface of an object O facing the operator according to at least one embodiment.

FIG. 14 is a field of view diagram in which the star pointer P having a thickness is displayed on an upper surface of the object O according to at least one embodiment.

FIG. 15 is a flow chart of a method for achieving display of the pointer P according to at least one embodiment.

FIG. 16 is a diagram of a system for executing the method according to at least one embodiment.

FIG. 17 is a diagram of angle information data that can be detected by an inclination sensor of a head-mounted display (HMD) according to at least one embodiment.

FIG. 18 is a diagram of points provided on the head-mounted display (HMD) and configured to emit infrared rays for a position tracking camera (position sensor) according to at least one embodiment.

FIG. 19 is a diagram of a configuration of components for executing the method according to at least one embodiment.

### DETAILED DESCRIPTION

First, details of at least one embodiment of this disclosure are listed and described. At least one embodiment of this disclosure has at least the following configuration.

(Item 1)

A virtual space position designation method for displaying a pointer indicating a place corresponding to a target of operation in a virtual space. The virtual space position designation method includes determining an actual line of sight and a provisional line of sight, the actual line of sight connecting between a position A of an eye of an operator in a virtual space and a position C separated from the position A by a distance x in a horizontal direction of the virtual space, the provisional line of sight connecting between the position C and a position B separated from the position A of the eye of the operator in the virtual space by a distance y₁ in a vertical direction of the virtual space. The method further includes displaying a pointer indicating a position corresponding to a target of operation at a point at which the provisional line of sight intersects with an object in the virtual space. The method further includes rendering the virtual space including the pointer based on the actual line of sight. The method further includes moving the provisional line of sight based on movement of the actual line of sight.

(Item 2)

A virtual space position designation method for displaying a pointer indicating a place corresponding to a target of operation in a virtual space according to Item 1, in which the position B is set at a position higher than the position A by the distance y₁ in the vertical direction of the virtual space and setting the position C at a position lower than the position A by a distance y₂ in the vertical direction of the virtual space.

(Item 3)

A virtual space position designation method for displaying a pointer indicating a place corresponding to a target of operation in a virtual space according to Item 1, in which the position B is set at a position lower than the position A by the distance y₁ in the vertical direction of the virtual space and setting the position C at a position higher than the position A by a distance y₂ in the vertical direction of the virtual space.

(Item 4)

A virtual space position designation method according to any one of Items 1 to 3, in which the displayed pointer is modified and displayed in such a form that the pointer adheres to a surface of the object in the virtual space. The virtual space position designation method described in Item 4 further includes displaying, in an emphasized manner, whether the pointer is present on an upper surface of an object or on other surfaces. Thus, operability is improved.

(Item 5)

A system for executing the method of any one of Items 1 to 4.

(Item 6) A non-transitory computer readable medium having recorded thereon a program for execution by the system for implementing the method of any one of Items 1 to 4.

(Item 7)

A virtual space position designation system configured to display a pointer indicating a place corresponding to a target of operation in a virtual space. The virtual space position designation device includes an initial line-of-sight calculation means for determining an actual line of sight and a provisional line of sight, the actual line of sight connecting between a position A of an eye of an operator in a virtual space and a position C separated from the position A by a distance x in a horizontal direction of the virtual space, the provisional line of sight connecting between the position C and a position B separated from the position A of the eye of the operator in the virtual space by a distance y₁ in a vertical direction of the virtual space. The system further includes a pointer display means for displaying a pointer indicating a position corresponding to a target of operation at a point at which the provisional line of sight intersects with an object in the virtual space. The system further includes a field-of-view image generation means for rendering the virtual space including the pointer based on the actual line of sight. The system further includes a line-of-sight movement means for moving the provisional line of sight based on movement of the actual line of sight.

(Item 8)

A virtual space position designation system configured to display a pointer indicating a place corresponding to a target of operation in a virtual space according to Item 7, in which the initial line-of-sight calculation means is configured to set the position B at a position higher than the position A by the distance y₁ in the vertical direction of the virtual space and set the position C at a position lower than the position A by a distance y₂ in the vertical direction of the virtual space.

(Item 9)

A virtual space position designation system configured to display a pointer indicating a place corresponding to a target of operation in a virtual space according to Item 8, in which the initial line-of-sight calculation means is configured to set the position B at a position lower than the position A by the distance y₁ in the vertical direction of the virtual space and set the position C at a position higher than the position A by a distance y₂ in the vertical direction of the virtual space.

(Item 10)

A virtual space position designation system according to any one of Items 7 to 9, in which the pointer displayed by the pointer display means is modified and displayed in such a form that the pointer adheres to a surface of the object in the virtual space. The virtual space position designation system described in Item 10 is capable of displaying, in an emphasized manner, whether the pointer is present on an upper surface of an object or on other surfaces. Thus, operability is improved.

Now, with reference to the drawings, at least one embodiment of this disclosure is described. In at least one embodiment, description is given based on a premise of the following immersive virtual space. In the immersive virtual space, a head-mounted display (HMD) including various sensors (for example, an acceleration sensor and an angular velocity sensor) and capable of measuring posture data of itself is used, and this posture data is used to scroll an image displayed on the head-mounted display (HMD) to achieve movement of a line of sight on the virtual space. However, this disclosure can be also applied to a case in which a virtual space is displayed on a normal display and the line of sight on the virtual space is moved based on input performed on a keyboard, a mouse, a joystick, or other devices. Further, the virtual space is a three-dimensional virtual space herein, but the virtual space is not necessarily limited thereto.

Further, in the drawings, like components are denoted by like reference symbols.

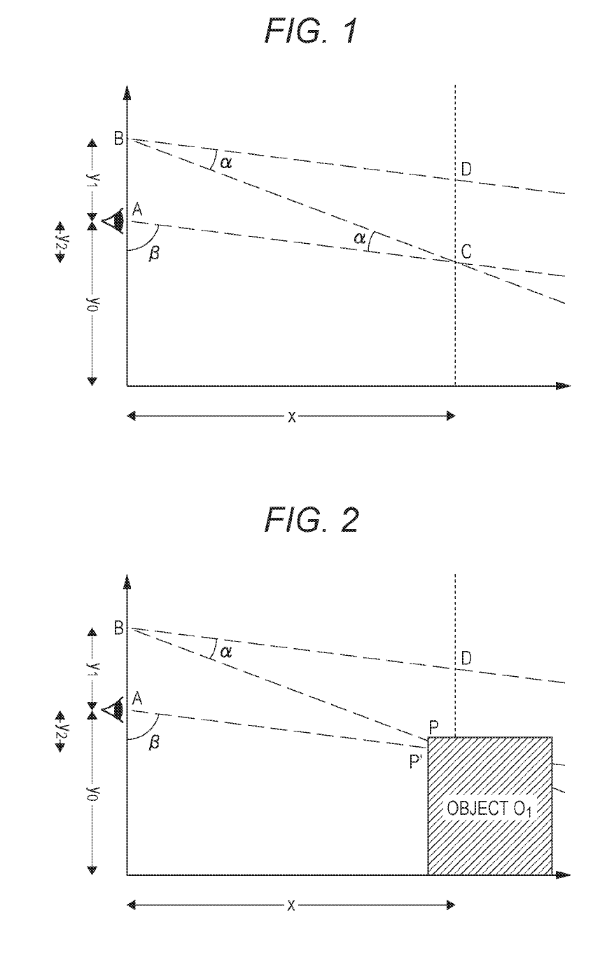

FIG. 1 is a diagram of a relationship among a position of an eye of an operator, a provisional line of sight, and an actual line of sight in this disclosure. FIG. 2 to FIG. 9 are diagrams of a relationship of first to fourth examples in which a point of gaze is determined based on the provisional line of sight in FIG. 1 in accordance with a distance between the operator and an object O.

In FIG. 1, a point A at a height y₀ represents the position of the eye of the operator. A point B is at a position vertically separated from the point A by a first distance y₁. A point C is at a position horizontally separated from the point A by a second distance x and vertically lowered by a third distance y₂ as viewed from the point A. A straight line AC connecting the point A and the point C represents an actual line of sight, and indicates a view of looking downward at an angle β. In at least one embodiment, the straight line AC is used to render the virtual space in a field of view of the operator.

A point D is a point at a position vertically separated from the point C by the first distance y₁. Therefore, the straight line AC is parallel to a straight line BD. A straight line BC and the straight line BD intersect with each other at the point B at an angle α, and the straight line BC and the straight line AC intersect with each other at the point C at the angle α. Therefore, the straight line BC indicates a view of looking downward at an angle β-α. The straight line BC corresponds to a provisional line of sight for designating the object being a target of operation.

The positional relationship among the points A, B, C, and D may be inverted upside down, and the straight line AC representing the actual line of sight may indicate an upward-looking view.

In at least one embodiment, a pointer is displayed at a point at which the straight line BC corresponding to the provisional line of sight for designating the object being the target of operation intersects with the object being the target of operation, and the object designated by the pointer is set to the target of operation. As initial setting, the height y₀, the first distance y₁, the second distance x, the third distance y₂, and the angles α and β may be set in accordance with characteristics of, for example, the object being the target of operation or a game that uses the object.

Now, with reference to FIG. 2 to FIG. 9, a relationship between the position of the object and the pointer is described.

FIG. 2 is a diagram in which a cuboid object O₁ being an operation target. Cuboid object O₁ blocks a view of the point C in FIG. 2; however, point C is in a same position as that indicated in FIG. 1.

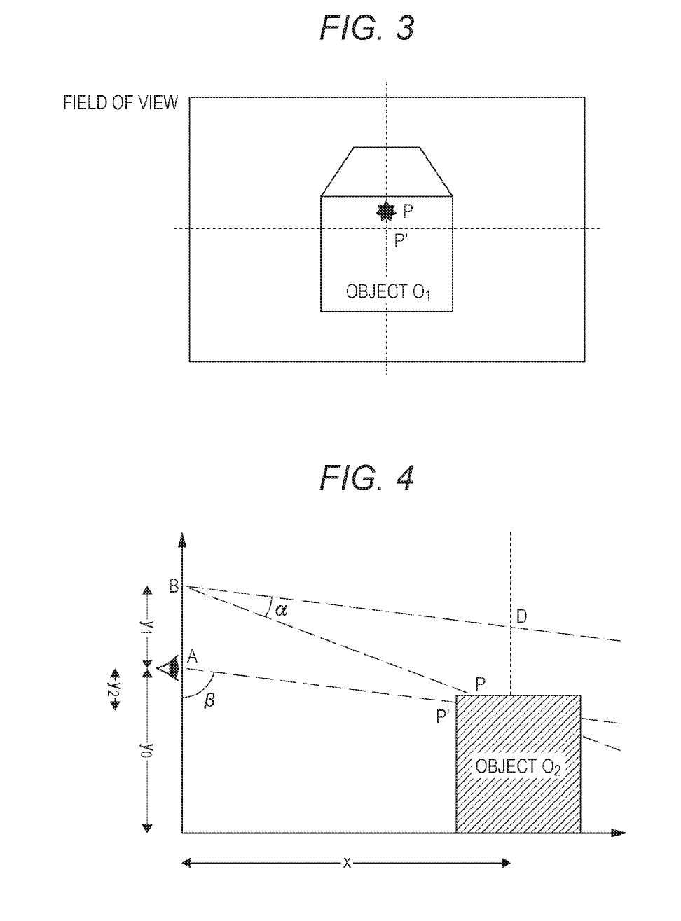

In FIG. 2, both of the straight line AC corresponding to the actual line of sight and the straight line BC corresponding to the provisional line of sight for designating the object being the target of operation intersect with a surface of the object O₁ facing the operator. In the virtual space, a pointer P is displayed at a point at which the straight line BC intersects with the surface of the object O₁ facing the operator. When the virtual space is actually rendered, based on a premise that the straight line AC corresponding to the actual line of sight is often rendered so as to be located at the center of the field of view in both of right-left and up-down directions, in FIG. 2, the pointer P is located above a point of gaze P′ at which the straight line AC corresponding to the actual line of sight intersects with the surface of the object O₁ facing the operator. Therefore, as in FIG. 3, the pointer P is rendered in the field of view of the operator so that, in the right-left direction, the pointer P is located at the center of the field of view similarly to the point of gaze P′, and in the up-down direction, the pointer P is located slightly above the center of the field of view corresponding to the point of gaze P′.

FIG. 4 is a diagram in which a cuboid object O₂ being an operation target. Cuboid object O₂ blocks a view of the point C in FIG. 4; however, point C is in a same position as that indicated in FIG. 1. The position of the object O₂ is closer to the operator side as compared to the position of the object O₁, i.e., a distance in the x-direction from the point A is less for object O₂ in FIG. 4 than for object O₁ in FIG. 1. The object O₂ and the object O₁ have the same shape and the same size.

In FIG. 4, the straight line AC corresponding to the actual line of sight intersects with the surface of the object O₂ facing the operator, but the straight line BC corresponding to the provisional line of sight for designating the object being the target of operation intersects with an upper surface of the object O₂.

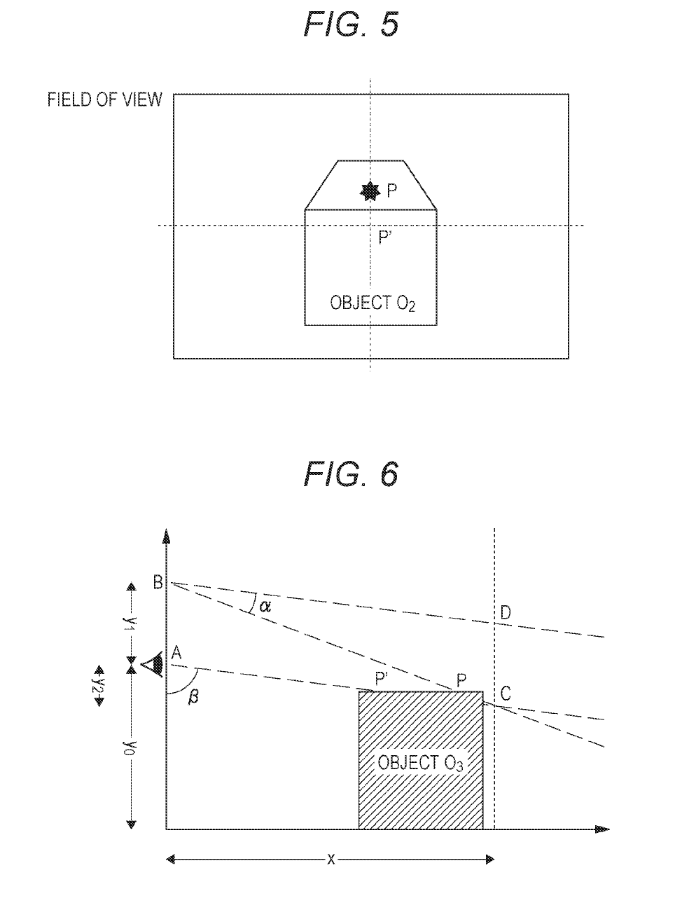

In the case of FIG. 4, as in FIG. 5, the pointer P is displayed on the upper surface of the object O₂.

FIG. 6 is a diagram in which a cuboid object O₃ being an operation target. The position of the object O₃ is closer to the operator side as compared to the position of the object O₂. The object O₁, the object O₂, and the object O₃ have the same shape and the same size.

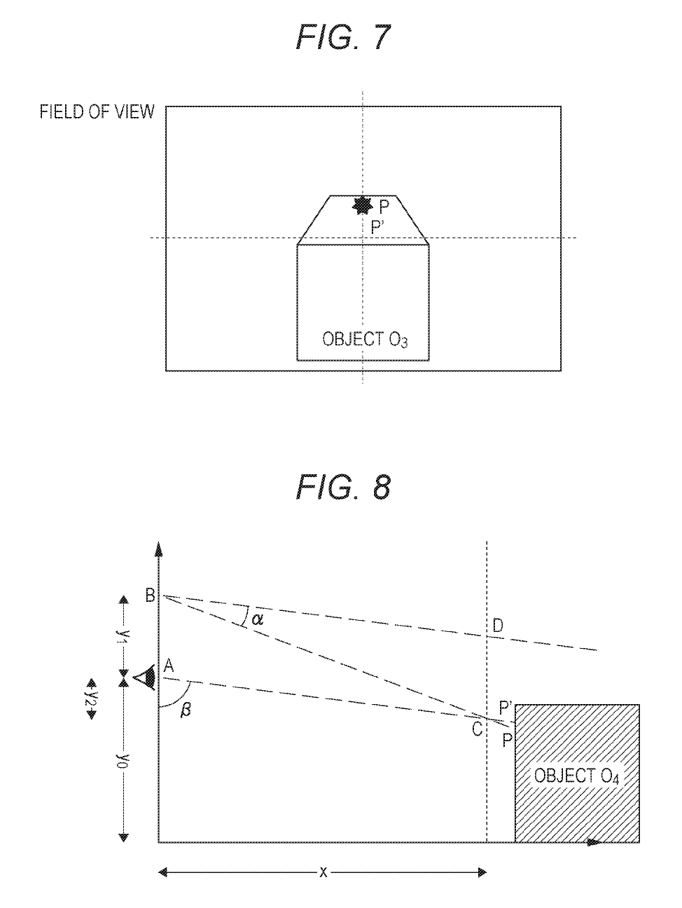

In FIG. 6, both of the straight line AC corresponding to the actual line of sight and the straight line BC corresponding to the provisional line of sight for designating the object being the target of operation intersect with the upper surface of the object O₃. Therefore, as in FIG. 7, the pointer P is displayed on the back side with respect to the point of gaze P′ of the upper surface of the object O₃.

FIG. 8 is a diagram in which a cuboid object O₄ being an operation target. The position of the object O₄ is farther from the operator as compared to the position of the object O₁. The object O₁, the object O₂, the object O₃, and the object O₄ have the same shape and the same size.

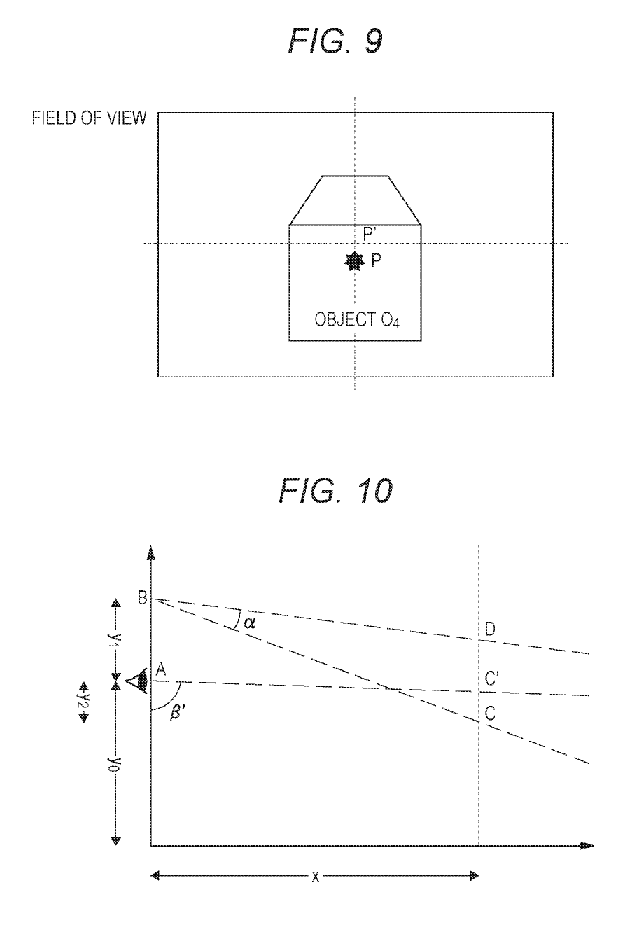

In FIG. 8, both of the straight line AC corresponding to the actual line of sight and the straight line BC corresponding to the provisional line of sight for designating the object being the target of operation intersect with the surface of the object O₄ facing the operator, but in contrast to FIG. 2, the pointer P is located below the point of gaze P′. That is, the actual field of view is displayed as in FIG. 9.

With use of the straight line BC corresponding to the provisional line of sight for designating the object being the target of operation instead of the straight line AC corresponding to the actual line of sight, for example in FIG. 4 and FIG. 5, the pointer P is displayed on the upper surface of the object O at a high probability. Further, when the pointer P is displayed on the upper surface of the object O at a high probability as described above, a user is able to easily perform operations on the upper surface of the object O, for example, raising or crushing the object O.

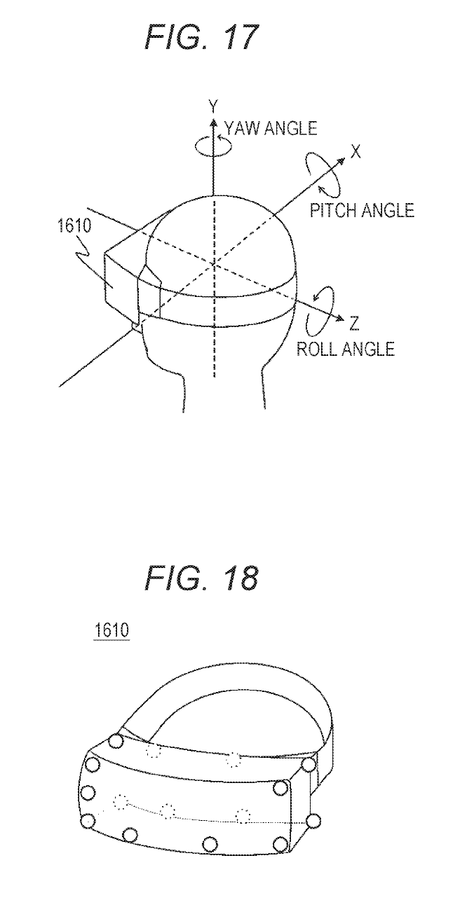

Description has been given so far of only the change in distance between the operator and the object O, that is, movement of the operator or the object O in a Z-axis direction of FIG. 17 for easy understanding of the description. Now, a case in which the line of sight of the operator is moved is described.

First, as a first example of the movement of the line of sight of the operator, there is given movement of the line of sight of the operator in a right-left horizontal direction. This movement occurs when the operator turns his or her head, i.e., the field of view is moved right or left due to rotation in a yaw angle direction about a Y axis of FIG. 17, or the operator himself or herself moves in the horizontal direction, that is, an X-axis direction of FIG. 17 in the virtual space. In this case, those movements may cause not only movement of the field of view but also change in distance between the operator and the object, but there is no effect on the display of the pointer P except for those cases. Therefore, detailed description is omitted herein.

Next, as a second example of the movement of the line of sight of the operator, there is given a case in which the operator himself or herself moves in the up-down direction in the virtual space, that is, the operator himself or herself moves in the Y-axis direction of FIG. 17 and thus the height y₀ of FIG. 1 is changed. In this case, processing can be made assuming that the straight line AC corresponding to the actual line of sight and the straight line BC corresponding to the provisional line of sight are translated in the up-down direction. The position of the pointer P is moved due to the movement of the straight line BC corresponding to the provisional line of sight. There is no particular significant effect on the display of the pointer P except for the change in rendering of the virtual space in the field of view due to the movement of the straight line AC, and hence detailed description is omitted herein.

Further, as a third example of the movement of the line of sight of the operator, there is given a case in which the head is inclined to right or left, that is, rotation is obtained in a roll angle direction about the Z axis of FIG. 17. Also in this case, the entire view is rotated, and the relative positional relationship between the straight line AC corresponding to the actual line of sight and the straight line BC corresponding to the provisional line of sight does not change. Therefore, there is no particular significant effect on the display of the pointer P except for the movement of the position of the pointer P due to the movement of the straight line BC corresponding to the provisional line of sight in the virtual space and the change in field of view in the up-down direction due to the rotation of the straight line AC corresponding to the actual line of sight. Therefore, detailed description is omitted herein.

In contrast, as a fourth example of the movement of the line of sight of the operator, there is given a case in which the head is shaken up and down, that is, the line of sight of the operator is swung in the up-down direction due to rotation in a pitch angle direction about the X axis of FIG. 17, that is, the angle β of FIG. 1 is changed. In at least one embodiment, special processing is used in this case.

As the processing for the fourth example, many methods can be conceived, and at least three representative methods are described below.

A first method is described with respect to FIG. 10. Although the angle β for looking downward changes and the straight line AC moves to a straight line AC′, the straight line BC is maintained without being changed from the initial position. In this case, the rendering of the virtual space in the field of view is changed under a state in which the position of the pointer P on the object O is not changed.

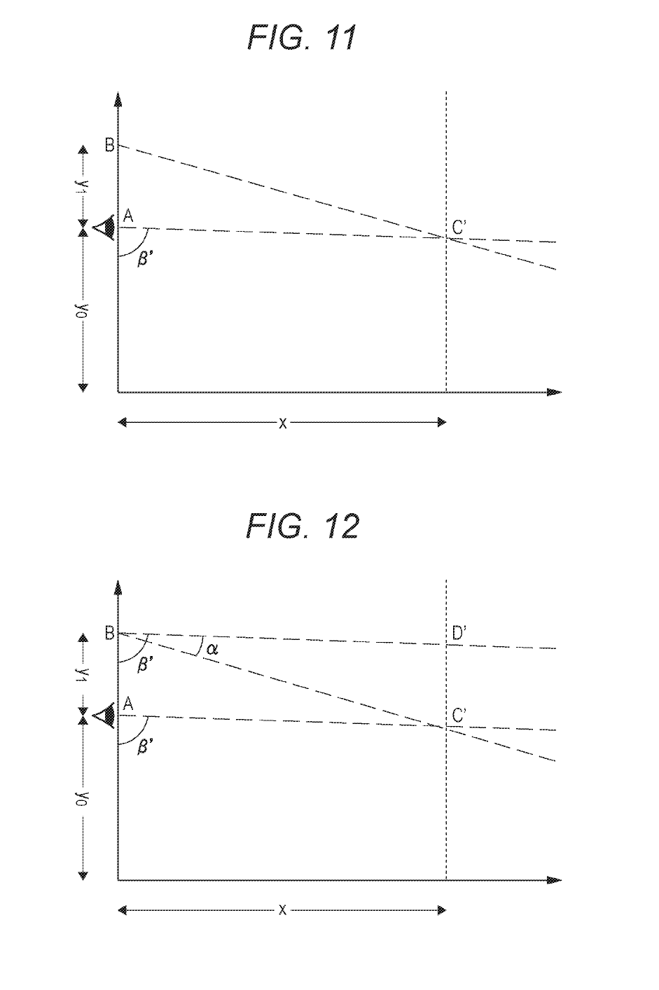

A second method is described with respect to FIG. 11. The angle β for looking downward changes and thus the straight line AC moves to the straight line AC′. Along therewith, the straight line BC moves to a straight line BC′, that is, intersection between the straight line AC and the straight line BC at a location of the distance x is maintained. In this case, both of the position of the pointer P on the object O and the rendering of the virtual space in the field of view are changed.

A third method is described with respect to FIG. 12. When the angle of the straight line AC for looking downward changes from β to β′, the angle of the straight line BC for looking downward changes from β-α to β′-α, that is, the angle α between the straight line BC and the straight line AC or the straight line BD is maintained. Also in this case, similarly to the second method, both of the position of the pointer P on the object O and the rendering of the virtual space in the field of view are changed.

In the first method, the change in angle β for looking downward does not cause change in position of the pointer P on the object O. Therefore, when the pointer P is mainly moved only in the right-left direction in the virtual space, the unconscious change in angle β for looking downward does not affect the position of the pointer P on the object O, which is convenient. In other words, in order to move the pointer P on the object O in the up-down direction of the field of view, the distance between the operator and the object O is required to be changed in the virtual space or the operator himself or herself is required to be moved in the up-down direction, and hence this method is not suitable for a case in which the pointer P is required to be moved in the virtual space or on the object O in the up-down direction of the field of view.

In contrast, in the second method and the third method, the change in angle β for looking downward causes change in position of the pointer P on the object O, and hence those methods are suitable for the case in which the pointer P is required to be moved in the virtual space or on the object O in the up-down direction of the field of view. However, when the angle β for looking downward changes, both of the position P′ of the point of gaze on the object O and the pointer P on the object O move but make different movements, and hence the operation may become difficult.

As described above, at least one embodiment has an effect that a user is able to easily perform operations with respect to the upper surface of the object O, for example, raising or crushing the object O. Further, when the pointer P is modified and displayed in such a form that the pointer P adheres to the surface of the object O, whether the pointer P is present on the upper surface of the object O or on other surfaces can be displayed in an emphasized manner. Thus, the operability is improved.

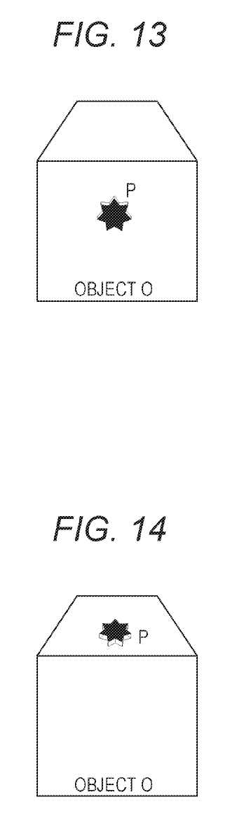

As specific examples, FIG. 13 and FIG. 14 are examples in which the pointer P is displayed as a three-dimensional star object having a thickness. In at least one example, a surface of the star having a thickness, which faces the operator, is colored, e.g., colored black, and other surfaces are transparent. FIG. 13 is an example in which the pointer P is modified and displayed so that it looks as if the star pointer P having a thickness adheres to the surface of the object O facing the operator. FIG. 14 is an example in which the pointer P is modified and displayed so that it looks as if the star pointer P having a thickness adheres to the upper surface of the object O.

In those examples, the pointer P is a three-dimensional object having a thickness, and hence whether the pointer P is present on the upper surface of the object O or on other surfaces is displayed in a more emphasized manner. However, even when the pointer P does not have a thickness, when the pointer P is modified and displayed in such a form that the pointer P adheres to the surface of the object O, whether the pointer P is present on the upper surface of the object O or on other surfaces can be made clear.

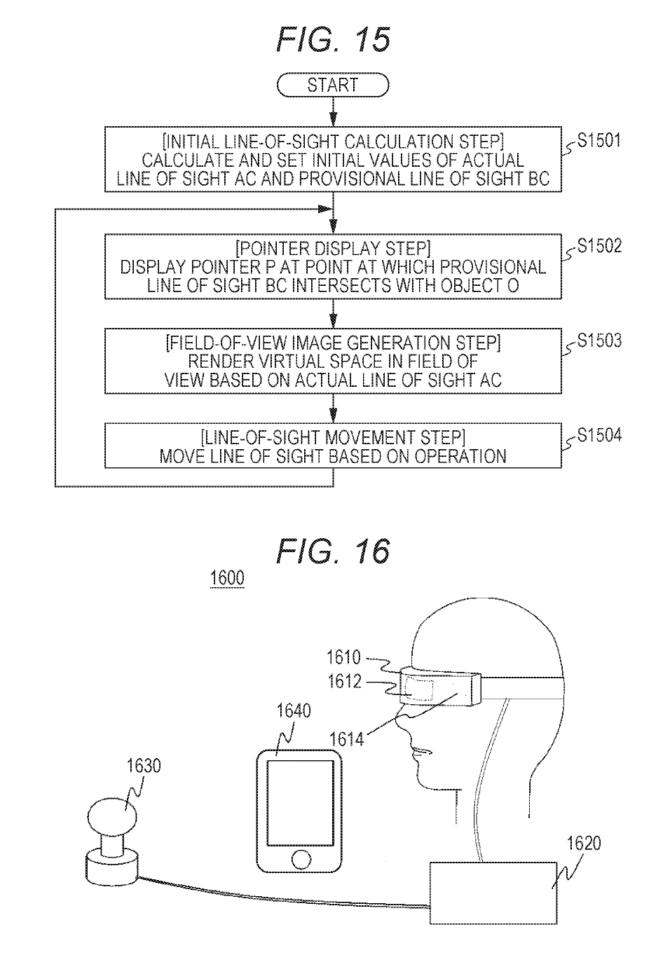

FIG. 15 is a flow chart of a method for achieving the display of the pointer P. The method is described with reference to FIG. 1 to FIG. 9. Details of parts corresponding to the parts described with reference to FIG. 10 to FIG. 12 are omitted for brevity.

Step S1501 is an initial line-of-sight calculation step. The actual line of sight connecting between the position A of the eye of the operator in the virtual space and the position C separated from the position A by the distance x in the horizontal direction of the virtual space and the provisional line of sight connecting between the position C and the position B separated from the position A of the eye of the operator in the virtual space by the distance y₁ in the vertical direction of the virtual space are determined as initial values.

Step S1502 is a pointer display step. The pointer P representing a place corresponding to the target of operation is displayed at a point at which the provisional line of sight intersects with the object in the virtual space. When the pointer P is displayed as in FIG. 13 and FIG. 14, in the pointer display step, the pointer P is modified and displayed in such a form that the pointer P adheres to the surface of the object O.

Step S1503 is a field-of-view image generation step. In the field of view that is based on the actual line of sight, the virtual space including the pointer is rendered.

Step S1504 is a line-of-sight movement step. The provisional line of sight is moved along with the movement of the actual line of sight, which occurs when the head of the operator is turned so that the field of view is moved to right or left, the operator himself or herself moves in the virtual space in the horizontal direction, or the operator himself or herself moves in the virtual space in the up-down direction. The processing of the case in which the line of sight of the operator is swung in the up-down direction, which occurs when the head is shaken up and down or the like as described with reference the above description of FIG. 10 to FIG. 12, is also performed in the line-of-sight movement step.

FIG. 16 is a block diagram of a system for executing the method.

In FIG. 16, a system 1600 includes a head-mounted display (HMD) 1610, a control circuit unit 1620, a position tracking camera (position sensor) 1630, and an external controller 1640.

The head-mounted display (HMD) 1610 includes a display 1612 and a sensor 1614. The display 1612 is a non-transmissive display device configured to completely cover a field of view of a user. The user can see only a screen displayed on the display 1612. The user wearing the non-transmissive head-mounted display (HMD) 1610 entirely loses his or her field of view of the outside world. Therefore, there is obtained a display mode in which the user is completely immersed in the virtual space displayed by an application executed in the control circuit unit 1620. In at least one embodiment, the display device 1612 is a partially transmissive display device.

The sensor 1614 included in the head-mounted display (HMD) 1610 is fixed near the display 1612. The sensor 1614 includes a geomagnetic sensor, an acceleration sensor, and/or an inclination (angular velocity or gyro) sensor. With use of at least one of those sensors, various movements of the head-mounted display (HMD) 1610 (display 1612) worn on the head of the user can be detected. Particularly in the case of the angular velocity sensor, as illustrated in FIG. 17, angular velocities about three axes of the head-mounted display (HMD) 1610 are detected over time in accordance with the movement of the head-mounted display (HMD) 1610, and the temporal change in angle (inclination) about each axis can be determined.

With reference to FIG. 17, angle information data that can be detected by the inclination sensor is described. In FIG. 17, XYZ coordinates are defined about the head of the user wearing the head-mounted display (HMD). A vertical direction in which the user stands upright is defined as the Y axis, a direction orthogonal to the Y axis and connecting between the center of the display 1612 and the user is defined as the Z axis, and an axis in a direction orthogonal to the Y axis and the Z axis is defined as the X axis. The inclination sensor detects the angle about each axis (that is, inclination determined based on a yaw angle representing rotation about the Y axis, a pitch angle representing rotation about the X axis, and a roll angle representing rotation about the Z axis), and a movement detection unit 1910 determines the angle (inclination) information data as field-of-view information based on the change over time.

Referring back to FIG. 16, the control circuit unit 1620 included in the system 1600 functions as a control circuit unit 1620 for immersing the user wearing the head-mounted display (HMD) in the three-dimensional virtual space and executing operations that are based on the three-dimensional virtual space. In FIG. 16, the control circuit unit 1620 may be constructed as hardware that is different from the head-mounted display (HMD) 1610. The hardware can be a computer, for example, a personal computer or a server computer via a network. That is, the hardware can be any computer including a CPU, a main memory, an auxiliary memory, a transmission/reception unit, a display unit, and an input unit that are connected by a bus.

Instead, the control circuit unit 1620 may be mounted on the head-mounted display (HMD) 1610 as an object operation device. In this case, the control circuit unit 1620 can perform all functions or only a part of the functions of the object operation device. When only a part of the functions is performed by control circuit unit 1620 mounted on the HMD 1610, the remaining functions may be performed by the head-mounted display (HMD) 1610 or on the server computer (not shown) via a network.

The position tracking camera (position sensor) 1630 included in the system 1600 is connected to the control circuit unit 1620 so as to enable communication therebetween, and has a function of tracking the position of the head-mounted display (HMD) 1610. The position tracking camera (position sensor) 1630 is implemented with use of an infrared sensor or a plurality of optical cameras. The system 1600 includes the position tracking camera (position sensor) 1630 configured to detect the position of the head-mounted display (HMD) on the user's head, and thus the system 1600 can accurately associate and identify a virtual space position of a vertical camera and the immersed user in the three-dimensional virtual space.

More specifically, the position tracking camera (position sensor) 1630 detects over time actual space positions of a plurality of detection points, which are virtually provided on the head-mounted display (HMD) 1610, as in FIG. 18, as an example and at which the infrared ray is detected, in accordance with the movement of the user. Then, based on the change over time of the actual space positions detected by the position tracking camera (position sensor) 1630, the temporal change in angle about each axis can be determined in accordance with the movement of the head-mounted display (HMD) 1610.

Referring back to FIG. 16, the system 1600 includes the external controller 1640. The external controller 1640 is a general user terminal and may be a smart phone, as in FIG. 16, but the external controller 1640 is not limited thereto. For example, the external controller 1640 may be any device as long as the external controller 1640 is a portable device terminal including a touch display, for example, a PDA, a tablet computer, a game console, and a notebook PC. That is, the external controller 1640 can be any portable device terminal including a CPU, a main memory, an auxiliary memory, a transmission/reception unit, a display unit, and an input unit that are connected by a bus. The user can perform various touch operations including tapping operation, swiping operation, and holding operation on the touch display of the external controller 1640.

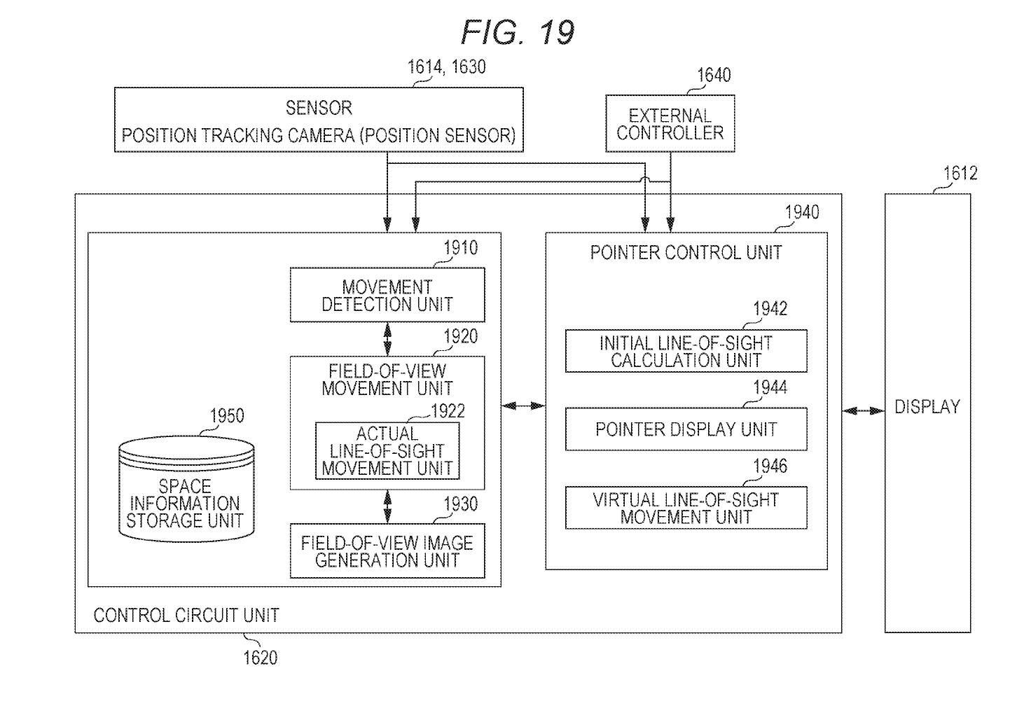

FIG. 19 is a block diagram of a configuration of primary functions of components of the control circuit unit 1620, according to at least one embodiment, for executing the method. The control circuit unit 1620 receives input from the sensor 1614 or the position tracking camera (position sensor) 1630 and the external controller 1640, and processes the input to output the processed data to the display 1612. The control circuit unit 1620 includes the movement detection unit 1910, a field-of-view movement unit 1920, a field-of-view image generation unit 1930, and a pointer control unit 1940, and processes various types of information.

The movement detection unit 1910 measures the movement data of the head-mounted display (HMD) 1610 worn on the head of the user based on the input of the movement information from the sensor 1614 or the position tracking camera (position sensor) 1630. In this disclosure, in particular, the angle information detected over time by the inclination sensor 1614 and the position information detected over time by the position tracking camera (position sensor) 1630 are determined.

The field-of-view movement unit 1920 determines the field-of-view information based on three-dimensional virtual space information stored in a space information storage unit 1950, and on detection information of a field-of-view direction of the virtual camera, which is based on the angle information detected by the inclination sensor 1614 and the position information detected by the position sensor 1630. An actual line-of-sight movement unit 1922 included in the field-of-view movement unit 1920 determines the actual line of sight in the three-dimensional virtual space, that is, the movement of the straight line AC, based on the field-of-view information. When the actual line of sight can be moved by detecting the movement of eyeballs and using some auxiliary input, the field-of-view movement unit 1920 and the actual line-of-sight movement unit 1922 further perform processing for this operation. The actual line-of-sight movement unit 1922 performs processing corresponding to the line-of-sight movement step S1504 together with a virtual line-of-sight movement unit 1946 to be described later, and can be treated as a line-of-sight movement unit as a whole. The processing of the case in which the line of sight of the operator is swung in the up-down direction, which occurs when the head is shaken up and down or the like as described above with reference to FIG. 10 to FIG. 12, is also performed by the line-of-sight movement unit.

The field-of-view image generation unit 1930 generates a field-of-view image based on the field-of-view information and the position of the pointer P transmitted from the pointer control unit 1940, and performs processing corresponding to the field-of-view image generation step S1503.

The pointer control unit 1940 is a unit that performs the control of the pointer in the field of view image. Specifically, the pointer control unit 1940 includes an initial line-of-sight calculation unit 1942, a pointer display unit 1944, and the virtual line-of-sight movement unit 1946.

The initial line-of-sight calculation unit 1942 sets the initial values of both of the actual line of sight, that is, the straight line AC, and the provisional line of sight, that is, the straight line BC, and performs processing corresponding to the initial line-of-sight calculation step S1501.

The pointer display unit 1944 places the pointer P at a point at which the provisional line of sight, that is, the straight line BC intersects with the object O, and performs processing corresponding to the pointer display step S1502. When the pointer is display as in FIG. 13 and FIG. 14, the pointer display unit 1944 modifies and displays the pointer P in such a form that the pointer P adheres to the surface of the object O.

The virtual line-of-sight movement unit 1946 moves the provisional line of sight, that is, the straight line BC in accordance with the movement of the actual line of sight, that is, the straight line AC. The virtual line-of-sight movement unit 1946 performs processing corresponding to the line-of-sight movement step S1504 together with the actual line-of-sight movement unit 1922 described above, and can be treated as the line-of-sight movement unit as a whole. As described above, the processing of the case in which the line of sight of the operator is swung in the up-down direction, which occurs when the head is shaken up and down or the like as described above with reference to FIG. 10 to FIG. 12, is also performed by the line-of-sight movement unit.

The respective elements in FIG. 19 are functional blocks for performing various types of processing and can be constructed by a CPU, a memory, and other integrated circuits in terms of hardware, and can be implemented by various programs loaded in the memory in terms of software. Therefore, it is understood by a person skilled in the art that those functional blocks can be implemented by hardware, software, or a combination thereof.

This disclosure has been described above with reference to at least one embodiment, but this disclosure is not limited to the details mentioned above. A person skilled in the art would understand that various modifications can be made to the at least one embodiment as long as the modifications do not deviate from the spirit and scope of this disclosure described in the appended claims.

1-10. (canceled)

11. A method, comprising:
defining a three-dimensional virtual reality space including a pointer object and a target object;
detecting an inclination of a head-mounted display (HMD);
defining a line of sight in the three-dimensional virtual reality space in accordance with the detected inclination of the HMD;
defining a provisional line of sight, wherein the provisional line of sight intersects with the line of sight;
identifying a position at which the provisional line of sight intersects with the target object in response to the line of sight intersecting with the target object;
arranging the pointer object at the position;
defining a field of view in the three-dimensional virtual reality space in accordance with a direction of the line of sight;
rendering a field-of-view image in accordance with the field of view; and
displaying the field-of-view image on the HMD.

12. The method according to claim 11,
wherein the defining of the line of sight comprises extending the line of sight from a point of view of an operator in a direction corresponding to the detected inclination of the HMD, and
the defining of the provisional line of sight comprises extending the provisional line of sight toward the target object from a position above the point of view, in response to the target object being lower than the point of view in the three-dimensional virtual reality space.

13. The method according to claim 11, wherein the line of sight and the provisional line of sight are extended in a same direction in the three-dimensional virtual reality space.

14. The method according to claim 11,
wherein the target object has a surface,
the position includes a position at which the line of sight intersects with the surface of the target object,
the arranging the pointer object comprises:
arranging the pointer object on the surface of the target object so that a predetermined surface of the pointer object is in contact with the surface of the target object at the position, and
moving the pointer object along the surface of the target object in accordance with movement of the detected inclination of the HMD.

15. A non-transitory computer readable medium storing instructions for causing a computer to:
define a three-dimensional virtual reality space including a pointer object and a target object;
detect an inclination of a head-mounted display (HMD);
define a line of sight in the three-dimensional virtual reality space in accordance with the detected inclination of the HMD;
define a provisional line of sight, wherein the provisional line of sight intersects with the line of sight;
identify a position at which the provisional line of sight intersects with the target object in response to the line of sight intersecting with the target object;
arrange the pointer object at the position;
define a field of view in the three-dimensional virtual reality space in accordance with a direction of the line of sight;
render a field-of-view image in accordance with the field of view; and
display the field-of-view image on the HMD.

16. A system, comprising:
a computer, the system being configured to, under control of a processor of the computer:
define a three-dimensional virtual reality space including a pointer object and a target object;
detect an inclination of a head-mounted display (HMD);
define a line of sight in the three-dimensional virtual reality space in accordance with the detected inclination of the HMD;
define a provisional line of sight, wherein the provisional line of sight intersects with the line of sight;
identify a position at which the provisional line of sight intersects with the target object in response to the line of sight intersecting with the target object;
arrange the pointer object at the position;
define a field of view in the three-dimensional virtual reality space in accordance with a direction of the line of sight;
render a field-of-view image in accordance with the field of view; and
display the field-of-view image on the HMD.

17. The system according to claim 16,
wherein the processor is configured to define the line of sight extending from a point of view of an operator in a direction corresponding to the detected inclination of the HMD, and
the processor is configured to define the provisional line of sight extending toward the target object from a position above the point of view, in response to the target object being lower than the point of view in the three-dimensional virtual reality space.

18. The system according to claim 16,
wherein the target object has a surface,
the position includes a position at which the line of sight intersects with the surface of the target object,
the processor is configured to arranging the pointer object on the surface of the target object so that a predetermined surface of the pointer object is in contact with the surface of the target object at the position, and
the processor is configured to move the pointer object along the surface of the target object in accordance with movement of the detected inclination of the HMD.
